(19) United States
(12) Patent Application Publication
(10) Pub. No.: US 2023/0095050 A1
(43) Pub. Date: Mar. 30, 2023

(54) DYNAMIC ENFORCEMENT OF CROSS-TENANT ACCESS POLICIES

(71) Applicant: Microsoft Technology Licensing, LLC, Redmond, WA (US)

(72) Inventors: Michael Thomas MCLEAN, Snoqualmie, WA (US); Rafael Bussioli Alves CORREA, Kirkland, WA (US)

(73) Assignee: Microsoft Technology Licensing, LLC, Redmond, WA (US)

(21) Appl. No.: 17/490,005

(22) Filed: Sep. 30, 2021

(51) Int. Cl. G06Q 10/10; H04L 29/06

(52) U.S. Cl. CPC G06Q 10/103; H04L 63/102

(57) ABSTRACT

Systems and methods for enforcing cross-tenant access policies during collaboration between internal users associated with a resource tenant and external users associated with a home tenant are provided. In particular, a computing device may host, by the resource tenant, a shared collaborative channel and receive a first cross-tenant access policy of the home tenant and a second cross-tenant access policy of the resource tenant. The shared collaborative channel may facilitate the collaboration between internal members associated with the resource tenant and external members associated with the home tenant, and the first cross-tenant access policy and the second cross-tenant access policy may define access to the one or more resources by the external members of the shared collaborative channel. The computing device may further receive at least one attribute for each external member of the shared collaborative channel and perform a cross-tenant access policy check for each external member.

### BACKGROUND

A collaborative platform provides a collaborative workspace to allow a team within an organization to stay connected and productive by providing easy access to team members, documents, and information. Expanded connectivity enables team members to make informed decisions and improve efficiency. Recent enhancements in collaboration platforms, further improve upon sharing documents, tracking tasks, e-mail efficacy, and idea and information sharing. However, oftentimes the collaborative workspace does not provide means to allow collaboration between individuals in different teams within the organization and/or collaboration with individuals or teams outside the organization.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In accordance with at least one example of the present disclosure, a method for enforcing cross-tenant access policies during collaboration between internal users associated with a resource tenant and external users associated with a home tenant is provided. The method may include hosting, by the resource tenant, a shared collaborative channel, wherein the shared collaborative channel facilitates the collaboration between internal members associated with the resource tenant and external members associated with the home tenant, wherein the shared collaborative channel includes one or more resources associated with the collaboration, and wherein the one or more resources are hosted on the resource tenant; receiving a first cross-tenant access policy of the home tenant and a second cross-tenant access policy of the resource tenant, wherein the first cross-tenant access policy and the second cross-tenant access policy define access to the one or more resources by the external members of the shared collaborative channel; performing a cross-tenant access policy check for each external member of the shared collaborative channel to determine whether the external member is in compliance with the first cross-tenant access policy of the home tenant and the second cross-tenant access policy of the resource tenant; and in response to determining that the external member is not in compliance with at least one of the first cross-tenant access policy of the home tenant or the second cross-tenant access policy of the resource tenant, flagging the external member as a non-compliant member of the shared collaborative channel.

In accordance with at least one example of the present disclosure, a computing device for enforcing cross-tenant access policies during collaboration between internal users associated with a resource tenant and external users associated with a home tenant is provided. The computing device may include a processor and a memory having a plurality of instructions stored thereon that, when executed by the processor, causes the computing device to perform operations hosting, by the resource tenant, a shared collaborative channel, wherein the shared collaborative channel facilitates the collaboration between internal members associated with the resource tenant and external members associated with the home tenant, wherein the shared collaborative channel includes one or more resources associated with the collaboration, and wherein the one or more resources are hosted on the resource tenant; receiving a first cross-tenant access policy of the home tenant and a second cross-tenant access policy of the resource tenant, wherein the first cross-tenant access policy and the second cross-tenant access policy define access to the one or more resources by the external members of the shared collaborative channel; receiving at least one attribute for each external member of the shared collaborative channel; performing a cross-tenant access policy check for each external member of the shared collaborative channel to determine whether the external member is in compliance with the first cross-tenant access policy of the home tenant and the second cross-tenant access policy of the resource tenant by comparing the attribute of each external member to the rules of the first cross-tenant access policy of the home tenant and the second cross-tenant access policy of the resource tenant; and in response to a determination that the external member is not in compliance with at least one of the first cross-tenant access policy of the home tenant or the second cross-tenant access policy of the resource tenant, flagging the external member as a non-compliant member of the shared collaborative channel.

In accordance with at least one example of the present disclosure, a computer-readable medium storing instructions for enforcing cross-tenant access policies during collaboration between internal users associated with a resource tenant and external users associated with a home tenant is provided. The instructions when executed by one or more processors of a computing device, cause the computing device to perform operations hosting, by the resource tenant, a shared collaborative channel, wherein the shared collaborative channel facilitates the collaboration between internal members associated with the resource tenant and external members associated with the home tenant, wherein the shared collaborative channel includes one or more resources associated with the collaboration, and wherein the one or more resources are hosted on the resource tenant; receiving a first cross-tenant access policy of the home tenant and a second cross-tenant access policy of the resource tenant, wherein the first cross-tenant access policy and the second cross-tenant access policy define access to the one or more resources by the external members of the shared collaborative channel; performing a cross-tenant access policy check for each external member of the shared collaborative channel to determine whether the external member is in compliance with the first cross-tenant access policy of the home tenant and the second cross-tenant access policy of the resource tenant; and in response to a determination that the external member is not in compliance with one of the first cross-tenant access policy of the home tenant or the second cross-tenant access policy of the resource tenant, flagging the external member as a non-compliant member of the shared collaborative channel; and generating an event notification to update a member link associated with the external member to indicate a non-compliant status of the external member.

Any of the one or more above aspects in combination with any other of the one or more aspects. Any of the one or more aspects as described herein.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 depicts details directed to a collaborative communication system for facilitating collaborations between users in accordance with examples of the present disclosure;

FIG. 2 depicts details directed to a collaborative communication system for facilitating collaborations between collaboration teams within an organization in accordance with examples of the present disclosure;

FIG. 3 depicts details directed to a collaborative communication system for facilitating collaborations between individuals and/or teams in different organizations in accordance with examples of the present disclosure;

FIGS. 4A-F depict example cross-tenant access policy configurations between a resource tenant and home tenants for collaboration in accordance with examples of the present disclosure;

FIG. 5 depicts a block diagram illustrating physical components (e.g., hardware) of a collaborative platform server with which aspects of the disclosure may be practiced;

FIGS. 6A-6C depict a method for enforcing cross-tenant access policies during collaboration between multiple tenants in accordance with examples of the present disclosure;

FIG. 7 depicts a block diagram illustrating physical components (e.g., hardware) of a computing device with which aspects of the disclosure may be practiced;

FIG. 8A illustrates a first example of a computing device with which aspects of the disclosure may be practiced;

FIG. 8B illustrates a second example of a computing device with which aspects of the disclosure may be practiced; and

FIG. 9 illustrates at least one aspect of an architecture of a system for processing data in accordance with examples of the present disclosure.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In accordance with examples of the present disclosure, a collaborative communication system allows individuals or collaboration teams in an organization (also referred to as a tenant) to create a collaborative enterprise environment on a collaborative platform (e.g., Microsoft® Teams®) with other individuals or collaboration teams within the organization and/or with other individuals or collaboration teams that belong to a different organization. Each user of the collaborative platform may customize the user's collaborative environment. Each collaboration team includes a group of team members and may have more than one collaborative channel shared among the team members. For example, a member of a collaboration team in an organization may create a collaborative channel to work on a project with other individuals in the same collaboration team and/or one or more members from a different collaboration team in the same organization. Collaboration may involve phone calls (e.g., IP-based calls), chat threads, email threads, channel conversations, document sharing, task tracking, scheduled meetings, and the like. Additionally, or alternatively, the collaborative channel may be shared with one or more individuals or teams outside of the organization (e.g., an external organization).

Each individual who has been invited or added to the collaborative channel may be assigned a specific set of rights (e.g., to access and interact with content in the collaborative channel) based at least in part on a type of the collaborative channel and an identity of the individual (e.g., within or outside the collaboration team, internal or external of the organization). For example, the type of a collaborative channel (e.g., standard, private, and shared) may be defined by an individual when creating the collaborative channel (also referred to as an owner of the collaborative channel). It should be appreciated that, in some aspects, the owner and/or one or more authorized members of the collaborative channel may modify the type of collaborative channel after the collaborative channel has been created. Additionally, it should also be appreciated that there may be multiple owners associated with the collaborative channel and owners may have additional authority to make changes to the collaborative channel than other members. As described above, regardless of the type of collaborative channel, an individual who is not a member of the collaboration team may be invited and/or added to the collaborative channel as a channel-only member. Additionally, in some aspects, a member of the collaboration team may also be explicitly added to a particular collaborative channel as a channel-only member. In such aspects, if the member is removed from the collaboration team, the member will retain access to the particular collaborative channel to which the member was added as the channel-only member.

As described above, the type of a collaborative channel may include standard, private, and shared. The standard collaborative channel is configured to establish an open collaboration within the collaboration team and inherits a roster (e.g., a full membership list) corresponding to the collaboration team. In other words, the standard collaborative channel and its contents are visible to every team member in the collaboration team. Even so, the owner of the collaborative channel may still maintain more rights than the other team members, such as rights to make changes to the roster, schedule meetings, grant rights to other members, and the like. It should be appreciated that, in some aspects, the standard collaborative channel may be public. For example, users in the same organization may access content in standard public channels.

The private collaborative channel is a channel where membership may be a subset of the team members in a collaboration team and/or a subset of members of an organization more broadly. The private collaborative channel and its contents are hidden from other team members (or organization members) who are not members of the private collaborative channel. For example, anyone in the collaboration team may create a private collaborative channel and invite one or more particular team members in the collaboration team to access the private collaborative channel. In fact, a team owner (e.g., a person who created the collaboration team) may not be a member of the private collaborative channel.

The shared collaborative channel allows cross-team collaboration between multiple collaborative teams within the same organization or across multiple organizations. The shared collaborative channel allows members in different teams to collaborate as if they were all members of the same collaboration team. When a shared collaborative channel is created, the originating member may be referred to as an originating owner. The originating owner is a member of an originating organization (e.g., internal organization) and may be (but is not required to be) a member of an internal collaboration team, for instance. The originating owner may invite members to the shared collaborative channel from different collaboration teams (e.g., internal collaboration teams) within the same organization (e.g., internal organization) and/or may invite members from different organizations (e.g., external organizations). If a member is associated with the same organization as the originating owner, the member is an internal member; whereas if a member is not associated with the same organization as the originating owner, the member is an external member. An internal member may be granted rights of an owner by the originating owner, which may include some or all of the rights held by the originating owner. In aspects, an external member may be granted rights as an external owner, but may not be granted all of the rights of an internal designated owner or the originating owner. That is, an external designated owner may not have rights to add or remove internal members from the membership roster of the shared collaborative channel but may have rights to add or remove external members (e.g., users from the same organization as the external designated owner). For example, if Organization A is collaborating with an external consulting firm like Organization B on a project, Organization A may not know how many individuals Organization B has allocated or when consultants will roll on or off the project. In such an example, Organization A may delegate managing a list of users within Organization B to an external owner member of Organization B. This allows Organization A to easily collaborate with Organization B without having to identify and update each and every consultant that rotates throughout the project.

In the illustrative aspect, when a new private or shared collaborative channel is created, a new substrate group may be provisioned within a resource tenant (i.e., where the new private or shared collaborative channel lives). The new substrate group is associated with the new collaborative channel and serves as an authority for membership (e.g., an identity management directory) inside the new collaborative channel. For example, the substrate group may contain a roster that includes a list of users and computers that are authorized to access resources or content associated with the collaborative channel. As such, a direct mapping (e.g., a 1:1 mapping) is established between the collaborative channel and the substrate group. The substrate group includes a group database for storing content (e.g., membership, messages, calendar entries) that is shared between members of the associated collaborative channel. Such content may be received, uploaded, or otherwise generated by the members and may be made available to multiple applications accessible by the members, including the collaborative platform, a calendar/messaging application, a planner application, a notebook application, and the like. It should be appreciated that the substrate group is independent from other identity management directories (e.g., Azure Active Directory) that may be associated with the collaboration team.

By creating a collaborative channel with its own substrate group, an individual may be added to a specific collaborative channel (e.g., channel-only members) for collaboration without being a member of the collaboration team. This allows the collaborative communication system to limit the access of channel-only members to content of the specific collaborative channel only. It should be appreciated that this is a significant improvement over current collaborative systems where all channels within a collaboration team share the same roster (e.g., same identity management directory) and the same group database, which in the case of a shared channel would result in all members, including users outside of the resource tenant (i.e., from different tenants), to have at least read access all content of the collaborative team. By bifurcating the membership roster of a shared collaborative channel from the general organizational directories, additional flexibility in assigning content permissions (e.g., read/write) and/or channel rights (e.g., changing membership, adding tasks, scheduling meetings, etc.) to both internal and external members can be achieved.

During collaboration between multiple organizations, cross-tenant access policies of the multiple organizations are implemented and enforced to ensure that all users participating in a shared collaborative channel are in compliance with the cross-tenant access policies of each of the multiple organizations, including a resource tenant (e.g., where the shared collaborative channel is hosted) and one or more home tenants (e.g., where the external users reside). Each cross-tenant access policy may include a collection of tenant groups, where every tenant group is a container for rules prescribing cross-tenant access policies for members of a shared collaboration channel. The tenant group includes a list of foreign tenants with which a tenant that owns the cross-tenant access policy has agreed to collaborate. However, for a shared collaboration channel to be established, the foreign tenants must also consent to collaboration with the tenant via their own cross-tenant access polices. In this way, the foreign tenants share the same level of trust as established by the tenant that owns the cross-tenant access policy. In other words, a shared collaboration channel is formed between two tenants if it satisfies cross-tenant access policies from both tenants. The cross-tenant access policies include a set of rules that indicate whether a user has access to retrieve data from the resource tenant and a scope of that access (e.g., an access level of the user). Each rule may include capabilities that are enabled for one or more users and conditions that include a specified collection of user identifiers, security groups, applications, and/or devices that have access permissions.

Additionally, the cross-tenant access policy may include authentication rules and authorization rules. The authentication rules define tenants for which native federation is allowed, including directionality (e.g., to or from my tenancy) and/or constraints (e.g., one or more security groups, applications, and/or devices). The authorization rules provide more granular control of what capabilities are enabled on top of the native federation. It should be appreciated that the term “federation” refers to different computing entities adhering to a certain standard of operations in a collective manner to facilitate communication.

During the collaboration between multiple tenants, checks of the cross-tenant access policies are performed for each and every external member to determine if the external member is in compliance with the cross-tenant access policies of a resource tenant (e.g., the host of the shared collaborative channel) and a respective home tenant (e.g., where the external member resides). For example, the cross-tenant access policy of the resource tenant may include a set of rules that indicate whether the home tenant has permissions to retrieve data stored in the resource tenant and a scope of that access (e.g., shared collaborative channel access, mixed chats, people search, etc.). Whereas, the cross-tenant access policy of the resource tenant may include a set of rules that indicate whether the home tenant that the external member is coming from has permissions to access to retrieve data stored in the resource tenant and a scope of that access. By periodically performing checks of the cross-tenant access policies on the external members, the cross-tenant access policies enforcement manager ensures that the external members remain compliant throughout the collaboration and that the external members are in compliance with the latest version of the cross-tenant access policies.

It should be appreciated that although, for exemplary purposes, described embodiments generally relate to applications, e.g., such as email applications, chat applications, collaborative platforms, and the like, the present methods and systems are not so limited. For example, collaboration content described herein may be used to provide collaborative experiences in applications other than messaging applications, such as word processing applications, spreadsheet applications, notebook applications, presentation applications, instant messaging or chat applications, social networking platforms, and the like.

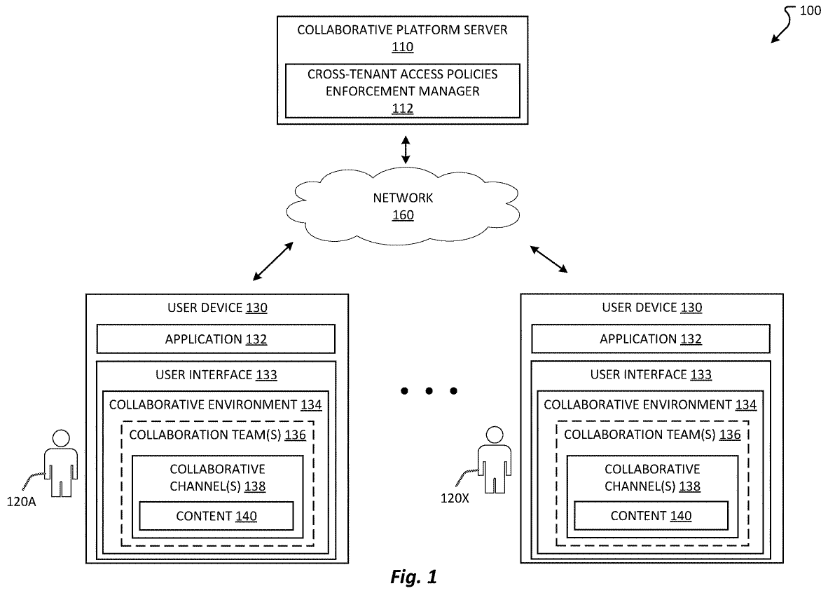

Specifically, FIG. 1 illustrates an overview of an example collaborative communication system 100 through which a member of a collaboration team 136 in an organization may collaborate with another member within or outside of the collaboration team 136 in the same or different organization via a collaborative platform server 110. The collaborative platform server 110 is associated with a collaborative platform, such as Microsoft Teams. In the illustrative aspect, the collaborative platform server 110 includes a cross-tenant access policies enforcement manager 112. The cross-tenant access policies enforcement manager 112 may implement and enforce cross-tenant access policies to create and maintain a relationship between multiple tenants for collaboration.

Content 140 may be shared and/or updated by one or more members of the shared collaborative channel 138 via an application 132 that is communicatively coupled to the collaborative platform server 110. For example, the content may include documents, agenda items, calendar items, action or task items, notes, or the like. It should be appreciated that any content (e.g., materials, documents, data, etc.) discussed or shared during a collaboration session may be automatically associated with the respective collaborative channel 138 and commonly stored (e.g., a substrate group database associated with the shared collaborative channel) that is accessible only by the members of the shared collaborative channel 138, based on any applicable permissions or rights to the content assigned to each member. In other words, the collaborative communication system 100 may provide a concurrent multi-user interaction and a real-time collaboration between the members of the shared collaborative channel 138—whether inside or outside of an organization.

As described above, each user 120 of the collaborative platform may customize the user's collaborative environment, which is displayable on a user interface 133 of the user device 130. It should be appreciated that each member of the shared collaborative channel 138 may choose where to link or mount the shared collaborative channel 138 within the user's collaborative environment. However, it should be appreciated that, in some aspects, the shared collaborative channel 138 may not be linked to a collaboration team 136 but instead linked to the user's collaborative environment as a standalone channel.

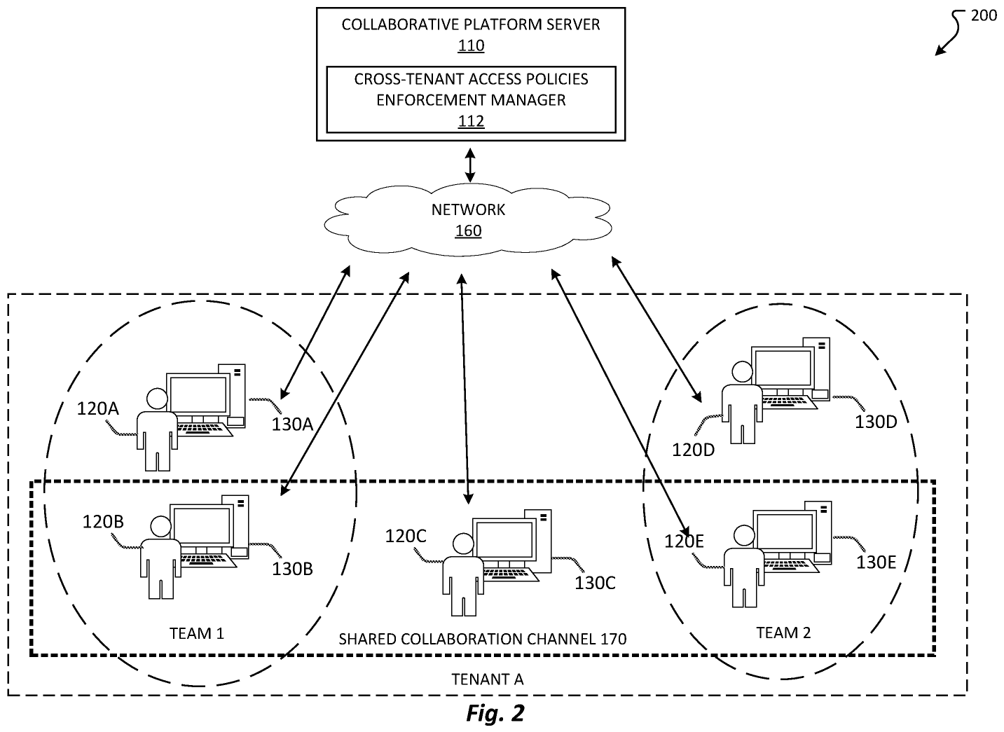

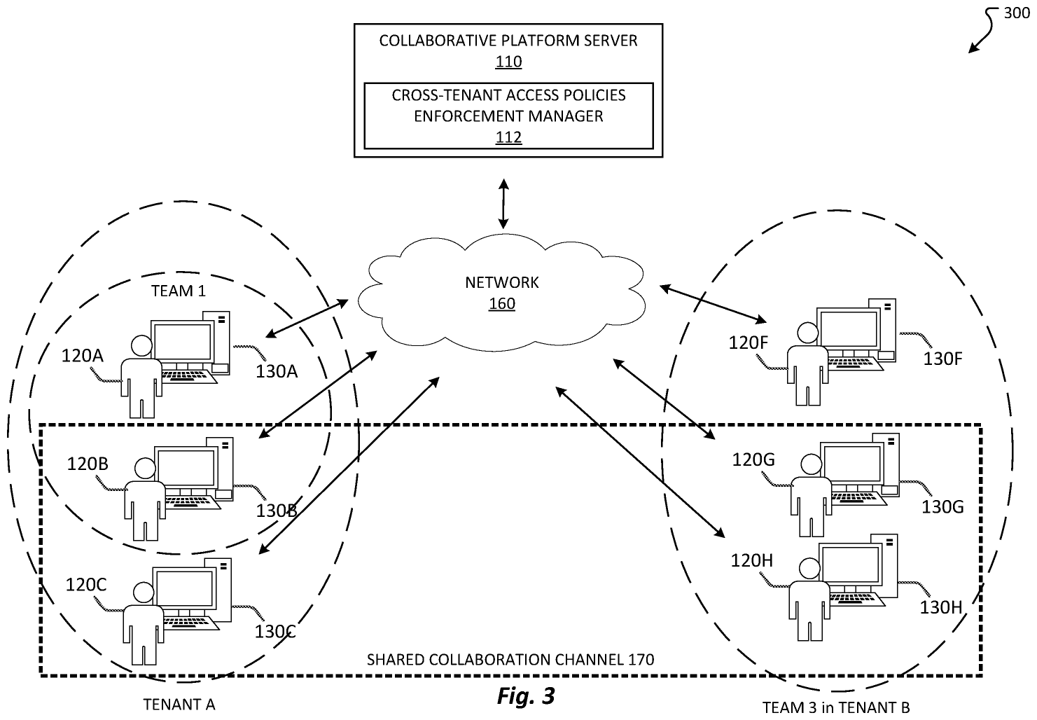

Referring now to FIGS. 2 and 3, an exemplary shared collaborative channel is illustrated. Specifically, FIG. 2 depicts an exemplary collaborative communication system 200 for facilitating collaborations between different collaboration teams within the same organization, in accordance with an embodiment of the present disclosure. In the illustrative aspect, the collaborative communication system 200 allows a member of one collaboration team in an organization to create a shared collaborative channel 170 on a collaborative platform with other individuals and/or collaboration teams within the same organization. To do so, the collaborative communication system 200 includes a collaborative platform server 110 that is communicatively coupled to a plurality of computing devices 130A-130E associated with users (e.g., members) 120A-120E in the same organization, Tenant A, via the network 160. As described above, the network 160 may include any kind of computing network including, without limitation, a wired or wireless local area network (LAN), a wired or wireless wide area network (WAN), and/or the Internet.

As shown in FIG. 2, Collaboration Team 1 has two team members 120A, 120B. Each team member 120A, 120B has a computing device 130A, 130B that is communicatively coupled to the collaborative platform server 110 to achieve collaboration within Collaboration Team 1. Additionally, Collaboration Team 1 may have more than one collaborative channel shared among the team members 120A, 120B. For example, the team member 120A (also referred to as a host or an originating channel owner from an originating collaboration team) may create a shared collaborative channel to initiate cross-team collaboration with Collaboration Team 2 in the same organization, Tenant A. When the shared collaborative channel is created, the membership of the shared collaborative channel may be defined as an aggregation of members from Collaboration Team 1 (i.e., the originating collaboration team) and Collaboration Team 2 (i.e., a recipient collaboration team). Additionally, the originating channel owner 120A may also invite a member 120C of Tenant A, who is not a member of any collaborative channel, to the shared collaborative channel.

Alternatively, or additionally, as depicted in FIG. 3, an exemplary collaborative communication system 300 may facilitate collaboration between collaboration teams across different organizations (i.e., cross-tenants), in accordance with an embodiment of the present disclosure. Specifically, in the illustrative aspect, the collaborative communication system 300 allows a member of one organization (whether a member of a collaboration team within the organization or not) to create a shared collaborative channel with other individuals and/or collaboration teams from another organization. To do so, the collaborative communication system 300 includes a collaborative platform server 110 that is communicatively coupled to a plurality of computing devices 130A-130C associated with members 120A-120C in Tenant A and a plurality of computing devices 130F-130H associated with members 120F-120H in Tenant B via the network 160.

As shown in FIG. 3, Collaboration Team 1 has three team members 120A, 120B. Each team member has a computing device 130A, 130B that is communicatively coupled to the collaborative platform server 110 to achieve collaboration within Collaboration Team 1. Additionally, Collaboration Team 1 may have more than one collaborative channel shared among the team members 120A, 120B. For example, the team member 120A (also referred to as a host or an originating channel owner from an originating collaboration team) may create a shared collaborative channel to initiate cross-team collaboration with Collaboration Team 3 from a different organization, Tenant B. When the shared collaborative channel is created, the membership of the shared collaborative channel may be defined as an aggregation of members from Collaboration Team 1 (i.e., the originating collaboration team) and Collaboration Team 3 (i.e., a recipient collaboration team). Additionally, the originating channel owner 120A may also invite a member 120C of Tenant A, who is not a member of any collaborative channel, to the shared collaborative channel.

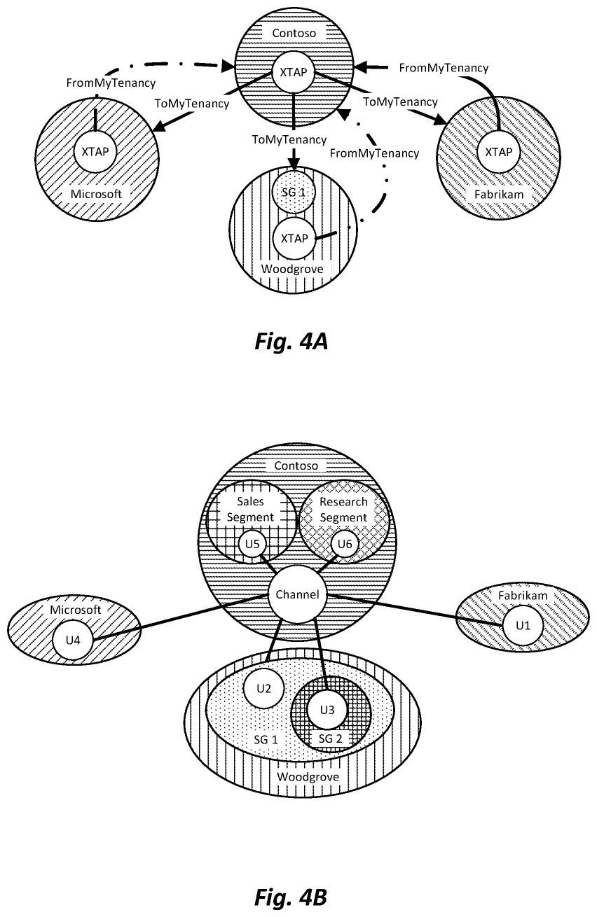

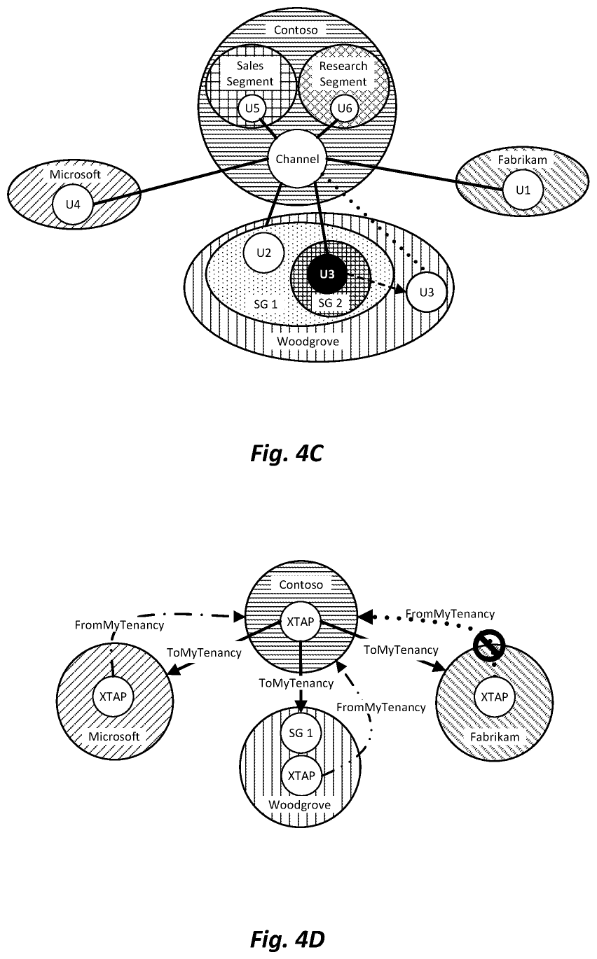

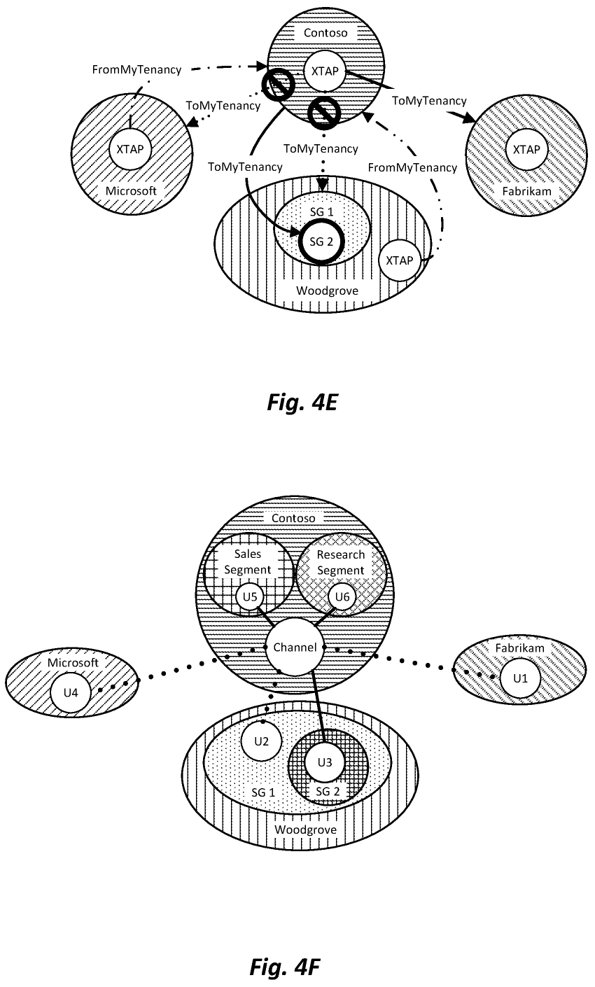

Referring now to FIGS. 4A-4F, example cross-tenant access policy configurations between a resource tenant and one or more home tenants for collaboration are provided, in accordance with an embodiment of the present disclosure. Specifically, in these examples, Contoso is a resource tenant (i.e., where a shared collaborative channel is hosted) and Microsoft, Woodgroove, and Fabrikam are home tenants.

For example, a cross-tenant access policy (XTAP) of Contoso (i.e., ToMyTenancy) may indicate that any user from Microsoft and Fabrikam is allowed on Contoso, as shown in FIG. 4A. However, Contoso may only allow access of Woodgrove users who are members of Security Group 1 (SG1). Additionally, each of cross-tenant access policies of Microsoft, Woodgrove, and Fabrikam may indicate that its users may access resources in external resource tenant, Contoso. During the collaboration, a shared collaborative channel may be created and hosted by Contoso with external members from Microsoft, Woodgrove, and Fabrikam, as shown in FIG. 4B. The shared collaborative channel is said to be a compliant channel because the external members are in compliance with the cross-tenant access policies (FIG. 4A). For example, the shared collaborative channel may be created in collaboration between a user U5 from a sales segment team and a user U6 from a research segment team in Contoso. Additionally, the shared collaborative channel may further include external users U1-U4 in accordance with the cross-tenant access policy of Contoso. For example, accesses of the users U2 and U3 are allowed because Contoso allows access of Woodgrove users who are members of SG1, which in turns includes SG2.

However, changes in the cross-tenant access policies may affect the compliance of users, as shown in FIGS. 4D-F. The changes in the cross-tenant access policies may be initiated on the home tenant side (FromMyTenancy) and/or the resource tenant side (ToMyTenancy). Changes to FromMyTenancy, which include permissions and conditions defining which one or more groups and/or one or more users from the home tenant may access resources in the resource tenant, may affect compliance of users from the home tenant across many groups, including the resource tenant. In this example, as shown in FIG. 4D, Fabrikam may change its cross-tenant access policy to disallow its users to access the external resource tenant, Contoso. In this case, the user U1 from Fabrikam would become a non-compliant member of the shared collaborative channel.

Additionally, changes to ToMyTenancy, which include permissions and conditions of which users in the one or more home tenants may access resources in the resource tenant, may affect compliance of users from one or more home tenants that are members of the shared collaborative channel in the resource tenant. In this example, as shown in FIG. 4E, Contoso may change its cross-tenant access policy to disallow access from Microsoft users and only allow access from users in the SG2 of Woodgrove. In this case, the user U2 from the SG1 of Woodgrove and the user U4 from Microsoft would become non-compliant members of the shared collaborative channel.

It should be appreciated that, even if there are no policy changes at an organization level, users may still become non-compliant. For example, changes on a user state may cause the cross-tenant access policy conditions to be broken (illustrated in a dotted line). For example, as shown in FIG. 4C, the user U3 may become non-compliant when the user U4 is moved out of the security groups, which was used as a constraint on the cross-tenant access policy.

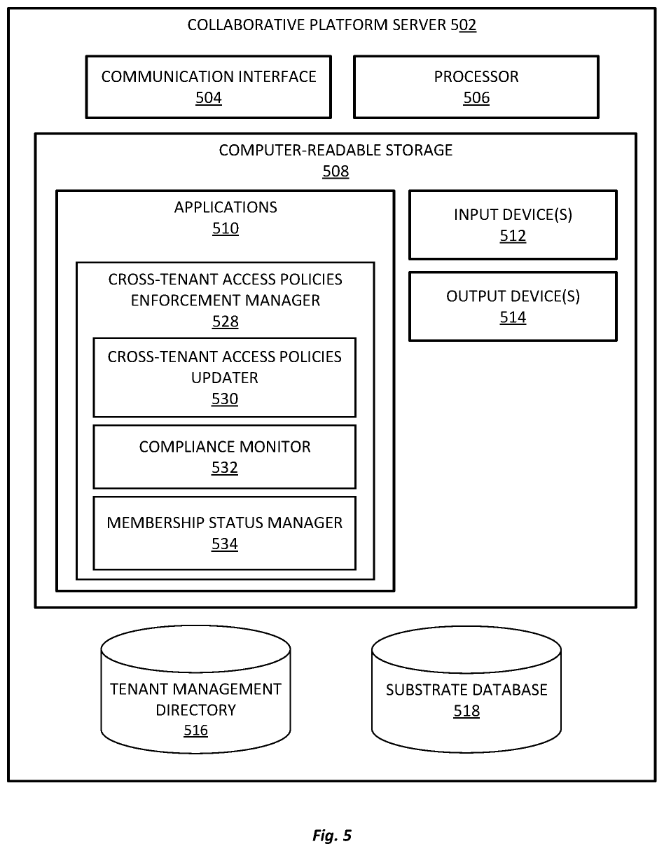

Referring now to FIG. 5, the collaborative platform server 502 in accordance with examples of the present disclosure is provided. The collaborative platform server 502 may be the same as or similar to the collaborative platform server 110 previously described in FIGS. 1-3. The collaborative platform server 502 may include a communication interface 504, a processor 506, a computer-readable storage 508, one or more input devices 512, and one or more output devices 514. In examples, the communication interface 504 may be coupled to a network and receive a cross-tenant access policy from a resource tenant (e.g., the owner of a shared collaborative channel) and from one or more home tenants. Additionally, one or more applications 510 may be provided by the collaborative platform server 502. The one or more applications 510 may include a cross-tenant access policies enforcement manager 528, which is configured to implement and enforce cross-tenant access policies to create and maintain a relationship between multiple tenants for collaboration. To do so, the cross-tenant access policies enforcement manager 528 further includes a cross-tenant access policy updater 530, a cross-tenant access compliance monitor 532, and a membership status manager 534.

The cross-tenant access policies updater 530 is configured to receive and update cross-tenant access policies. Each cross-tenant access policy may include a collection of tenant groups, where every tenant group is a container for rules prescribing cross-tenant access permissions and constraints. The tenant group includes a list of foreign tenants with which a tenant that owns the cross-tenant access policy has agreed to collaborate. However, for a shared collaboration channel to be established, the foreign tenants must also consent to collaboration with the tenant via their own cross-tenant access polices. In this way, the foreign tenants share the same level of trust as established by the tenant that owns the cross-tenant access policy. In other words, a shared collaboration channel is formed between two tenants if it satisfies cross-tenant access policies from both tenants. The cross-tenant access policies include a set of rules that indicate whether a user has access to retrieve data from the resource tenant and a scope of that access (e.g., an access level of the user). Each rule may include capabilities that are enabled for one or more users and conditions that include a specified collection of user identifiers, security groups, applications, and/or devices that have access permissions.

For example, the cross-tenant access policies updater 530 may receive cross-tenant access policies from the resource tenant (e.g., the owner of a shared collaborative channel) and/or from one or more home tenants. In the illustrative aspect, the cross-tenant access policies updater 530 stores the received cross-tenant access policy in in a tenant management directory (e.g., 516, Azure® Active Directory®), which is synced down to one or more substrate databases (e.g., 518) of one or more substrate groups, each of which is associated with a respective shared collaborative channel. As discussed above, the shared collaborative channel is hosted on the resource tenant to facilitate collaboration between members from the resource tenant and the one or more home tenants. Additionally, the cross-tenant access policies updater 530 is configured to determine if a cross-tenant access policy associated with the resource or home tenant already exists in the management directory. If so, the cross-tenant access policies updater 530 updates the existing cross-tenant access policy with the updated cross-tenant access policy.

The cross-tenant access policies compliance monitor 532 is configured to perform checks on cross-tenant access policies for all external members based on external member information (e.g., a user identifier, an external tenant identifier, and a resource identifier) to ensure that all external members are in compliance with the cross-tenant access policies from the home and resource tenants. Such checks on the cross-tenant access policies may be performed periodically, continually, and/or on demand.

The cross-tenant access policies compliance monitor 532 may check a cross-tenant access policy of a resource tenant (e.g., the owner of the shared collaborative channel) for an external member. For example, the cross-tenant access policy of the resource tenant may include a set of rules that indicate whether the home tenant of the external member permits retrieving data stored on the resource tenant and a scope of that access (e.g., shared collaborative channel access, mixed chats, people search, etc.). As an example, the cross-tenant access policy of the resource tenant may include a ToMyTenancy rule, which includes permissions and conditions for external users in the one or more home tenants to access resources in the resource tenant. As such, the policy changes initiated by the resource tenant (e.g., by changing ToMyTenancy rules) may affect compliance of external users from one or more home tenants that are members of groups (e.g., one or more shared collaborative channels) on the resource tenant.

In another example, the cross-tenant access policies compliance monitor 532 may check a cross-tenant access policy of a home tenant (i.e., where the external member resides) for the external member The cross-tenant access policy of the home tenant may include a set of rules that indicate whether users of the home tenant are permitted to retrieve data from a resource tenant and a scope of that access (e.g., shared collaborative channel access, mixed chats, people search, etc.). It should be appreciated that changes in the cross-tenant access policy of the home tenant may affect the compliance of external users from the home tenant across many groups on the resource tenant. As an example, the cross-tenant access policy of the home tenant may include FromMyTenancy rule, which includes permissions and conditions under which one or more external groups and/or one or more external users from the home tenant may access resources on the resource tenant.

By doing so, the cross-tenant access policies compliance monitor 532 ensures that the external members remain compliant throughout the collaboration with the latest version of the cross-tenant access policies. The cross-tenant access policies compliance monitor 532 is further configured to transmit the results of checking the cross-tenant access policies to the membership status manager 534.

The membership status manager 534 is configured to manage and update a compliance status of each external user based on checking the cross-tenant access policies. For example, the membership status manager 534 is configured to flag or mark the external user as non-compliant if the membership status manager 534 determines that the external user failed the cross-tenant access policies check and is not presently flagged or marked as non-compliant. In some aspects, the membership status manager 534 is further configured to terminate the membership of the external user from the shared collaborative channel if the membership status manager 534 determines that the external user failed the cross-tenant access policies check and has been in the non-compliant status longer than a predefined time period (e.g., 7 days). Additionally, the membership status manager 534 may unflag or mark the external user as compliant if the external user is in compliance with the cross-tenant access policies but is presently flagged or marked as non-compliant, which means that, for example, the external user failed a previous cross-tenant access policies check.

The membership status manager 534 is further configured to generate an event notification to update a member link associated with the external user, indicating a compliant status of the external user. In some aspects, the membership status manager 534 is configured to generate a report for the tenant administrator. The report may include an event log with one or more flagging/unflagging events and/or one or more membership termination events with reasons for membership termination.

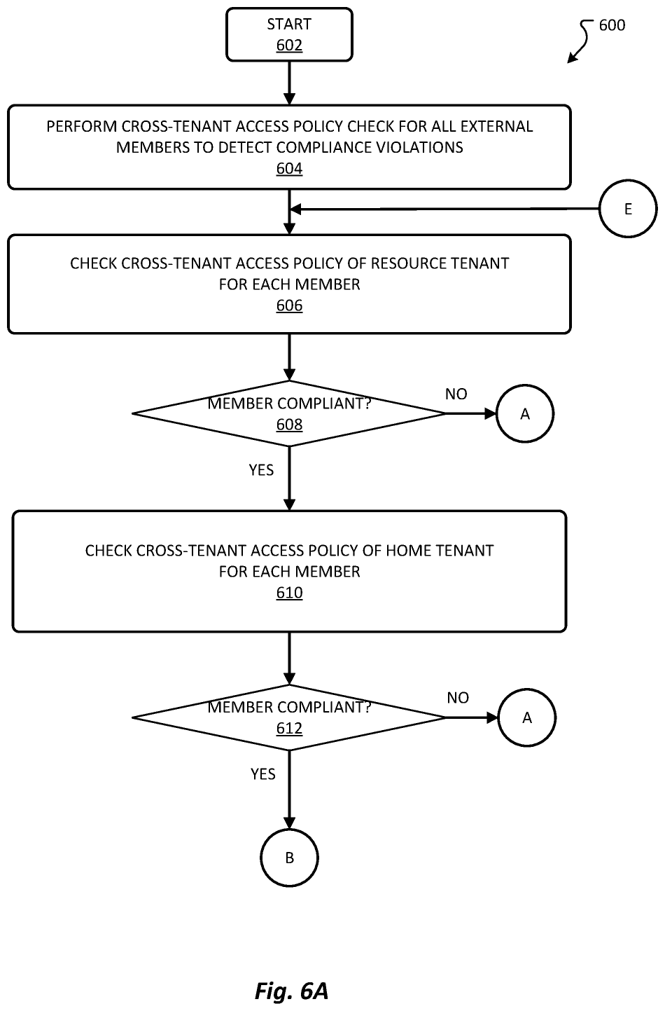

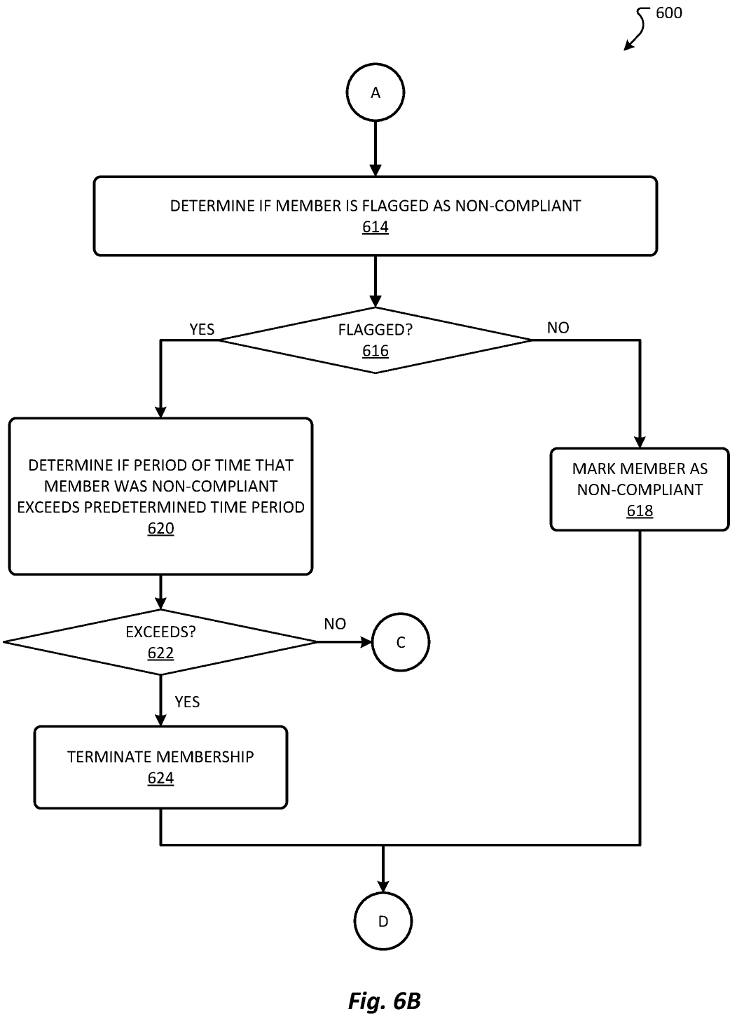

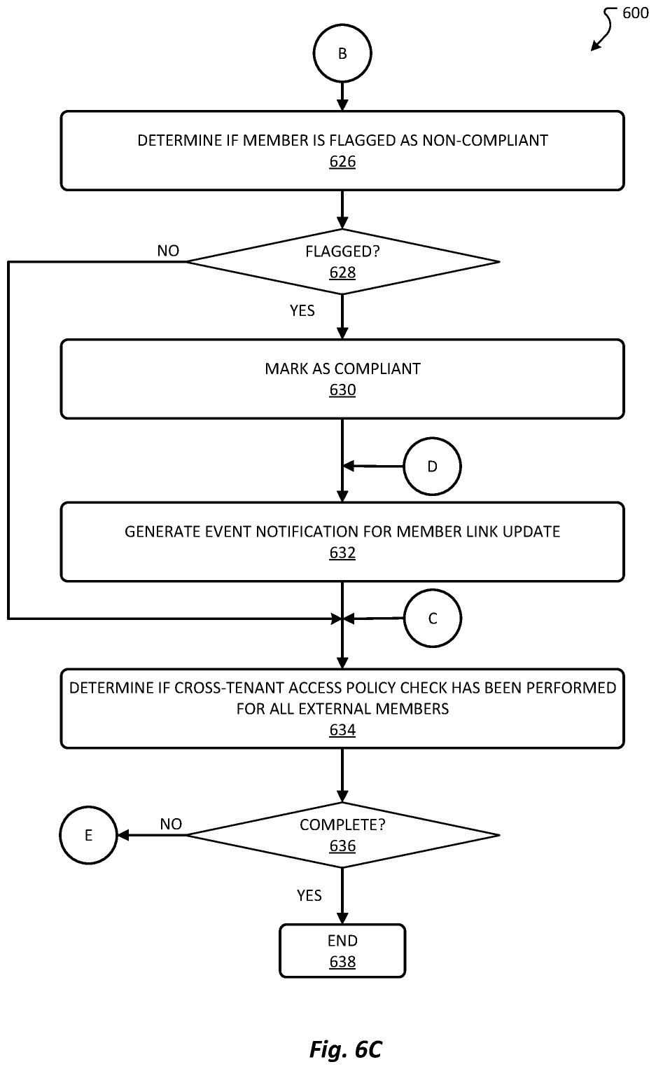

Referring now to FIGS. 6A-6C, a method 600 for enforcing cross-tenant access policies during collaboration between multiple tenants in accordance with examples of the present disclosure is provided. In order to create a relationship between multiple tenants for collaboration, cross-tenant access policies are implemented and enforced. For example, the cross-tenant access policies are stored in a tenant management directory (e.g., 516, Azure® Active Directory®) and one or more substrate databases (e.g., 518) of one or more substrate groups, each of which is associated with a respective shared collaborative channel. As described above, each cross-tenant access policy may impact multiple tenant groups, where every tenant group is a container for rules prescribing cross-tenant access permissions and constraints for members of a substrate group associated with a shared collaboration channel. The tenant group includes a list of foreign tenants with which a tenant that owns the cross-tenant access policy has agreed to collaborate. However, for a shared collaboration channel to be established, the foreign tenants must also consent to collaboration with the tenant via their own cross-tenant access polices. In this way, the foreign tenants share the same level of trust as established by the tenant that owns the cross-tenant access policy. In other words, a shared collaboration channel is formed between two tenants if it satisfies cross-tenant access policies from both tenants. The cross-tenant access policies may include a set of rules that indicate whether a user has access to retrieve data from a resource tenant and a scope of that access (e.g., an access level of the user). Specifically, each rule includes a permission or a restraint for enabling one or more external users to access resource data on a resource tenant, such as a specified collection of user identifiers, security groups, applications, and/or devices that have access permissions. In some aspects the cross-tenant access policies may specify a set of resources associated with a shared resource channel and stored on the resource tenant. In this case, the external user may only be able to request access to one or more resources of the specified set of resources, which prevents the external user from requesting or accessing other resources on the resource tenant.

In the illustrative aspect, the method 600 is performed by a cross-tenant access policies enforcement manager (e.g., 112, 528) of a collaborative platform server (e.g., 110, 500). A general order for the steps of the method 600 is shown in FIGS. 6A-6C. Generally, the method 600 starts at 602 and ends at 638. The method 600 may include more or fewer steps or may arrange the order of the steps differently than those shown in FIGS. 6A-6C. The method 600 can be executed as a set of computer-executable instructions executed by a computer system and encoded or stored on a computer readable medium. Further, the method 600 can be performed by gates or circuits associated with a processor, Application Specific Integrated Circuit (ASIC), a field programmable gate array (FPGA), a system on chip (SOC), or other hardware device. Hereinafter, the method 600 shall be explained with reference to the systems, components, modules, software, data structures, user interfaces, etc. described in conjunction with FIG. 1.

The method 600 starts at 602, where flow may proceed to 604. In operation 604, the cross-tenant access policies enforcement manager performs a cross-tenant access policy check for all external members to detect compliance violations. It should be appreciated that the cross-tenant access policies are periodically or continually updated to ensure that the cross-tenant access policy check is performed against current cross-tenant access policies. For example, the cross-tenant access policies enforcement manager may periodically perform a cross-tenant access policy check (e.g., every 24 hours). However, in some aspects, a check of the cross-tenant access policies may be triggered on demand. It should be appreciated that cross-tenant access policy checks are performed for each of external members. Accordingly, the cross-tenant access policies enforcement manager repeats operations 606-632 until the cross-tenant access policy checks are completed on each external member. It should be appreciated that the cross-tenant access policy checks may be performed for the external members simultaneously or sequentially.

To do so, in operation 606, the cross-tenant access policies enforcement manager retrieves and checks a cross-tenant access policy of a resource tenant (e.g., the owner of the shared collaborative channel) against the attributes of each external member (e.g., a user identifier, an external tenant identifier, and a resource identifier). For example, the cross-tenant access policy of the resource tenant may include a set of rules that indicate whether one or more external users are permitted to retrieve data stored in the resource tenant and a scope of that access (e.g., shared collaborative channel access, mixed chats, people search, etc.). Accordingly, the cross-tenant access policies enforcement manager may compare the attributes of each external member to the cross-tenant access policy of the resource tenant to determine whether the external member is permitted to retrieve data stored in the resource tenant. For example, the cross-tenant access policies enforcement manager may check if the external tenant where the external member resides is identified as one of the allowed external tenants that may access resources on the resource tenant. In such a case, the cross-tenant access policies enforcement manager determines that the external member is in compliance with the cross-tenant access policies.

If the cross-tenant access policies enforcement manager determines that the external member is not in compliance with the cross-tenant access policies at 608, the method 600 skips ahead to operation 614 in FIG. 6B as shown by the alphanumeric character A in FIGS. 6A and 6B. If, however, the cross-tenant access policies enforcement manager determines that the external member is in compliance with the cross-tenant access policies, the method 600 proceeds to operation 610.

In operation 610, the cross-tenant access policies enforcement manager checks a cross-tenant access policy of a home tenant (i.e., where the external member resides) against the attributes of each external member. For example, the cross-tenant access policy of the home tenant may include a set of rules that indicate whether users of the home tenant are permitted to retrieve data from a resource tenant and a scope of that access (e.g., shared collaborative channel access, mixed chats, people search, etc.). It should be appreciated that changes in the cross-tenant access policy of the home tenant may affect the compliance of external users from the home tenant across many substrate groups on resource tenant. If the cross-tenant access policies enforcement manager determines that the external member is not in compliance with the cross-tenant access policies at 608, the method 600 skips ahead to operation 612 in FIG. 6B as shown by the alphanumeric character A in FIGS. 6A and 6B.

In operation 614 in FIG. 6B, the cross-tenant access policies enforcement manager determines if the external member is already flagged as non-compliant. If the cross-tenant access policies enforcement manager determines that the external member is not presently flagged or marked as non-compliant, the method 600 proceeds to operation 618. In operation 618, the cross-tenant access policies enforcement manager flags or marks the external member as non-compliant. The method 600 subsequently proceeds to operation 632 in FIG. 6C as shown by the alphanumeric character D in FIGS. 6B and 6C.

If, however, the external member is determined to be already flagged as non-compliant in operation 616, the method 600 advances to operation 620. In operation 620, the cross-tenant access policies enforcement manager determines if a period of time that the external member was non-compliant exceeds a predetermined time period (e.g., 7 days). If the cross-tenant access policies enforcement manager determines that the external member has been in non-compliance longer than the predetermined time period, the method 600 advances to operation 624 to terminate the membership of the external member. In other words, the non-compliant external member is evicted from the shared collaboration channel if the external member remains non-compliant past the predetermined time period. Not terminating or evicting the external member when first flagged as non-compliant allows tenant administrators and/or the external user to resolve potential mistakes and/or address the issue(s) for becoming compliant.

Subsequently, the method 600 proceeds to operation 632 in FIG. 6C as shown by the alphanumeric character D in FIGS. 6B and 6C. In operation 632, the cross-tenant access policies enforcement manager generates an event notification to update a member link associated with the external user, indicating a compliant status of the external user.

If, however, the non-compliant time period of the external member does not exceed the predetermined time period in operation 622, the method 600 skips ahead to operation 634 in FIG. 6C as shown by the alphanumeric character C in FIGS. 6B and 6C, which is described further below.

Referring back to operation 612 in FIG. 6A, if the cross-tenant access policies enforcement manager determines that the external member is in compliance with the cross-tenant access policies, the method 600 proceeds to operation 626 in FIG. 6C as shown by the alphanumeric character B in FIGS. 6A and 6C.

In operation 626, the cross-tenant access policies enforcement manager determines whether the external member is already flagged or marked as non-compliant. If the cross-tenant access policies enforcement manager determines that the external member is not presently flagged or marked as non-compliant in operation 628, the cross-tenant access policies enforcement manager determines that the external member is in compliance and the cross-tenant access policy check for the external member is complete. Subsequently, the method 600 skips ahead to operation 634, which is described further below.

If, at operation 612, the cross-tenant access policies enforcement manager determines that the external member is in compliance with the cross-tenant access policies, and if, at operation 626, the cross-tenant access policies enforcement manager determines that the external member is already flagged or marked as non-compliant, the method 600 advances to operation 630 to unflag or mark the external user as compliant. Subsequently, in operation 632, the cross-tenant access policies enforcement manager generates an event notification to update a member link associated with the external user, indicating a compliant status of the external user. In some aspects, the cross-tenant access policies enforcement manager may generate a report for the tenant administrators. The report may include an event log with one or more flagging/unflagging events and/or one or more membership termination events with reasons for membership termination.

Subsequent to determining that the cross-tenant access policies check is complete for the external member, the method 600 advances to operation 634 to determine if the cross-tenant access policy checks have been performed for all external members. If the cross-tenant access policies enforcement manager determines that the cross-tenant access policy checks have not been performed for all external members in operation 636, the method 600 loops back to operation 606 in FIG. 6A as shown by the alphanumeric character E in FIGS. 6C and 6A to perform a cross-tenant access policy check for another external member. If, however, the cross-tenant access policy checks are performed for all external members, then the method 600 may end at 638.

By performing the cross-tenant access policies checks on the external members periodically, the cross-tenant access policies enforcement manager ensure that the external members remain compliant throughout the collaboration. Additionally, the periodic cross-tenant access policies checks ensure that the external members are in compliance with the latest version of the cross-tenant access policies.

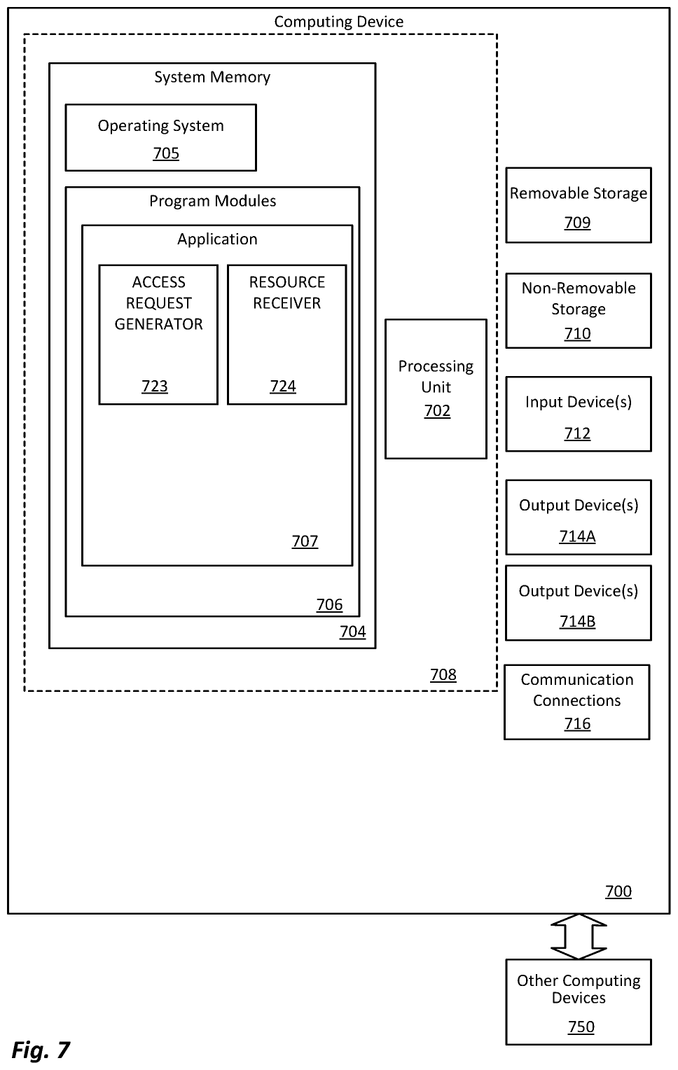

FIGS. 7-9 and the associated descriptions provide a discussion of a variety of operating environments in which aspects of the disclosure may be practiced. However, the devices and systems illustrated and discussed with respect to FIGS. 7-9 are for purposes of example and illustration and are not limiting of a vast number of computing device configurations that may be utilized for practicing aspects of the disclosure, described herein.

FIG. 7 is a block diagram illustrating physical components (e.g., hardware) of a computing device 700 with which aspects of the disclosure may be practiced. The computing device components described below may be suitable for the computing devices described above. For example, the computing device 700 may represent the computing device 130 of FIG. 1. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories.

The system memory 704 may include an operating system 705 and one or more program modules 706 suitable for performing the various aspects disclosed herein such. The operating system 705, for example, may be suitable for controlling the operation of the computing device 700. Furthermore, aspects of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, several program modules and data files may be stored in the system memory 704. While executing on the at least one processing unit 702, the program modules 706 may perform processes including, but not limited to, one or more aspects, as described herein. The application 720 includes an access request generator 723 and a resource receiver 724. The access request generator 723 is configured to generate a request to access resources on a shared collaborative channel of a cross-tenant. For example, the request may include an identification of a home tenant where the user is (i.e., where the access request is coming from) and an identification of a resource tenant where the shared collaborative channel lives (i.e., where the resource is). The resource receiver 724 is configured to receive requested resources from the shared collaborative channel.

Other program modules that may be used in accordance with aspects of the present disclosure may include electronic mail and contacts applications, word processing applications, spreadsheet applications, database applications, slide presentation applications, drawing or computer-aided application programs, etc., and/or one or more components supported by the systems described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The computing device 700 may also have one or more input device(s) 712 such as a keyboard, a mouse, a pen, a sound or voice input device, a touch or swipe input device, etc. The output device(s) 714A such as a display, speakers, a printer, etc. may also be included. An output 714B, corresponding to a virtual display may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media (e.g., non-transitory media). Computer storage media may include non-transitory, volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

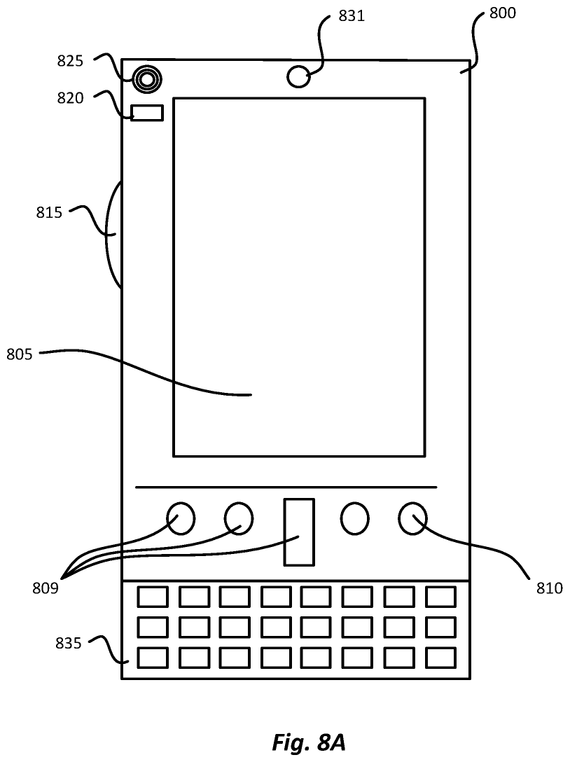

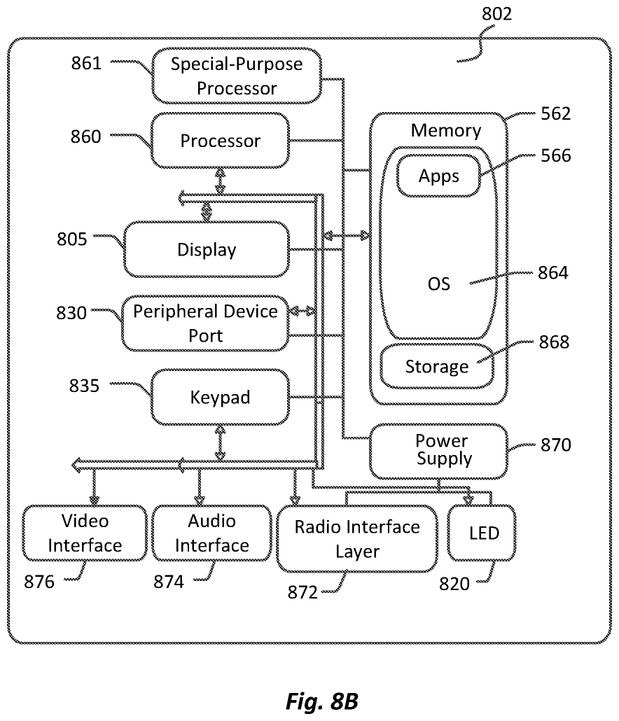

FIGS. 8A and 8B illustrate a computing device or mobile computing device 800, for example, a mobile telephone, a smart phone, wearable computer (such as a smart watch), a tablet computer, a laptop computer, and the like, with which aspects of the disclosure may be practiced. With reference to FIG. 8A, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 809/810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative aspects, mobile computing device 800 may incorporate more or less input elements. For example, the display 805 may not be a touch screen in some aspects. In yet another alternative aspect, the mobile computing device 800 is a portable phone system, such as a cellular phone. The mobile computing device 800 may also include an optional keypad 835. Optional keypad 835 may be a physical keypad or a “soft” keypad generated on the touch screen display. In various aspects, the output elements include the display 805 for showing a graphical user interface (GUI), a visual indicator 831 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports 830, such as an audio input (e.g., a microphone jack), an audio output (e.g., a headphone jack), and a video output (e.g., a HDMI port) for sending signals to or receiving signals from an external source.

FIG. 8B is a block diagram illustrating the architecture of one aspect of computing device, a server, or a mobile computing device. That is, the mobile computing device 800 can incorporate a system (902) (e.g., an architecture) to implement some aspects. The system 802 can implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and/or one or more components supported by the systems described herein. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800 described herein (e.g. an access request generator 723, a resource receiver 724, etc.).

The system 802 has a power supply 870, which may be implemented as one or more batteries. The power supply 870 might further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via the audio transducer 825. In the illustrated configuration, the visual indicator 820 is a light emitting diode (LED) and the audio transducer 825 is a speaker. These devices may be directly coupled to the power supply 870 so that when activated, they remain on for a duration dictated by the notification mechanism even though the processor 860/961 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with aspects of the present disclosure, the microphone may also serve as an audio sensor to facilitate control of notifications, as will be described below. The system 802 may further include a video interface 876 that enables an operation of an on-board camera to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

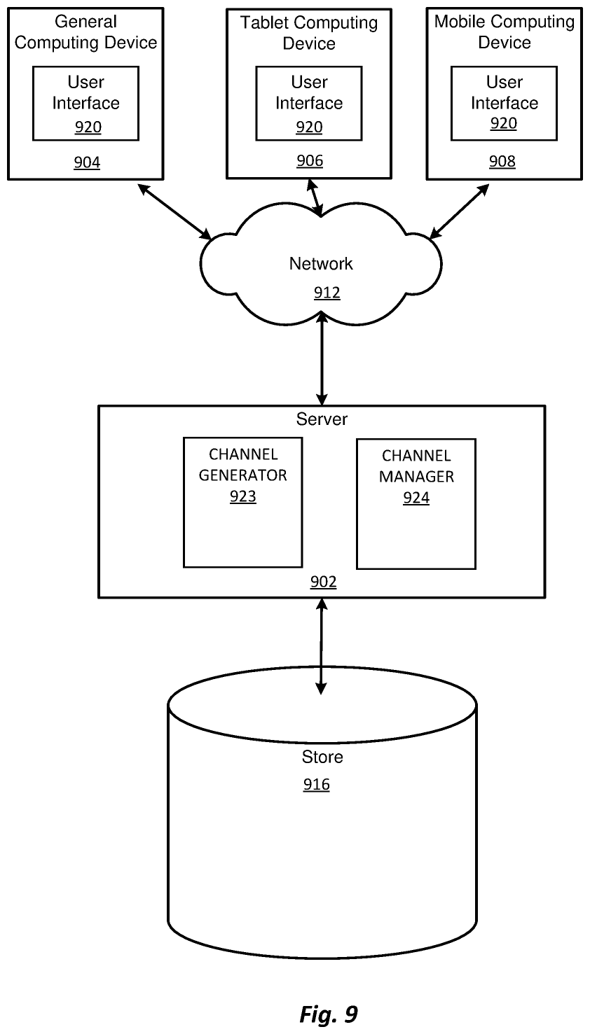

FIG. 9 illustrates one aspect of the architecture of a system for processing data received at a computing system from a remote source, such as a personal computer 904, tablet computing device 906, or mobile computing device 908, as described above. Content displayed at server device 902 may be stored in different communication channels or other storage types. For example, the computing device 904, 906, 908 may represent the computing device 130 of FIGS. 1-3, and the server device 902 may represent the collaborative platform server 110 of FIG. 1.

In some aspects, one or more of a channel generator 923 and a channel manager 924, may be employed by server device 902. The server device 902 may provide data to and from a client computing device such as a personal computer 904, a tablet computing device 906 and/or a mobile computing device 908 (e.g., a smart phone) through a network 912. By way of example, the computer system described above may be embodied in a personal computer 904, a tablet computing device 906 and/or a mobile computing device 908 (e.g., a smart phone). Any of these aspects of the computing devices may obtain content from the store 916, in addition to receiving graphical data useable to be either pre-processed at a graphic-originating system, or post-processed at a receiving computing system.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

In accordance with at least one example of the present disclosure, a method for enforcing cross-tenant access policies during collaboration between internal users associated with a resource tenant and external users associated with a home tenant is provided. The method may include hosting, by the resource tenant, a shared collaborative channel, wherein the shared collaborative channel facilitates the collaboration between internal members associated with the resource tenant and external members associated with the home tenant, wherein the shared collaborative channel includes one or more resources associated with the collaboration, and wherein the one or more resources are hosted on the resource tenant; receiving a first cross-tenant access policy of the home tenant and a second cross-tenant access policy of the resource tenant, wherein the first cross-tenant access policy and the second cross-tenant access policy define access to the one or more resources by the external members of the shared collaborative channel; performing a cross-tenant access policy check for each external member of the shared collaborative channel to determine whether the external member is in compliance with the first cross-tenant access policy of the home tenant and the second cross-tenant access policy of the resource tenant; and in response to determining that the external member is not in compliance with at least one of the first cross-tenant access policy of the home tenant or the second cross-tenant access policy of the resource tenant, flagging the external member as a non-compliant member of the shared collaborative channel.

In accordance with at least one aspect of the above method, the method may further include receiving at least one attribute for each external member of the shared collaborative channel, and performing the cross-tenant access policy check by comparing the attribute of each external member to the rules of the first cross-tenant access policy of the home tenant and the second cross-tenant access policy of the resource tenant.

In accordance with at least one aspect of the above method, the method may further include generating an event notification to update a member link associated with the external member, indicating a non-compliant status of the external member.

In accordance with at least one aspect of the above method, wherein flagging the external member as the non-compliant member of the shared collaborative channel may further include determining whether the external member is flagged as non-compliant, and in response to determining that the external member is not flagged as non-compliant, flagging the external member as the non-compliant member of the shared collaborative channel.

In accordance with at least one aspect of the above method, the method may further include in response to determining that the external member is flagged as non-compliant, determining a period of time that the external member has been flagged as non-compliant, determining whether the period of time exceeds a predetermined time period, and in response to determining that the period of time exceeds the predetermined time period, terminating a membership of the external member to the shared collaborative channel.

In accordance with at least one aspect of the above method, the method may further include in response to determining that the external member is in compliance with both the first cross-tenant access policy of the home tenant and the second cross-tenant access policy of the resource tenant, determining if the external member is flagged as non-compliant, and in response to determining that the external member is flagged as non-compliant, unflagging the external member as non-compliant.

In accordance with at least one aspect of the above method, the method may further include determining if the cross-tenant access policy check has been performed for all external members of the shared collaborative channel.

In accordance with at least one aspect of the above method, the method may further include receiving an update to at least one of the first cross-tenant access policy of the home tenant and the second cross-tenant access policy of the resource tenant, and performing the cross-tenant access policy check based on the update.

In accordance with at least one example of the present disclosure, a computing device for enforcing cross-tenant access policies during collaboration between internal users associated with a resource tenant and external users associated with a home tenant is provided. The computing device may include a processor and a memory having a plurality of instructions stored thereon that, when executed by the processor, causes the computing device to perform operations including hosting, by the resource tenant, a shared collaborative channel, wherein the shared collaborative channel facilitates the collaboration between internal members associated with the resource tenant and external members associated with the home tenant, wherein the shared collaborative channel includes one or more resources associated with the collaboration, and wherein the one or more resources are hosted on the resource tenant; receiving a first cross-tenant access policy of the home tenant and a second cross-tenant access policy of the resource tenant, wherein the first cross-tenant access policy and the second cross-tenant access policy define access to the one or more resources by the external members of the shared collaborative channel; receiving at least one attribute for each external member of the shared collaborative channel; performing a cross-tenant access policy check for each external member of the shared collaborative channel to determine whether the external member is in compliance with the first cross-tenant access policy of the home tenant and the second cross-tenant access policy of the resource tenant by comparing the attribute of each external member to the rules of the first cross-tenant access policy of the home tenant and the second cross-tenant access policy of the resource tenant; and in response to a determination that the external member is not in compliance with at least one of the first cross-tenant access policy of the home tenant or the second cross-tenant access policy of the resource tenant, flagging the external member as a non-compliant member of the shared collaborative channel.

In accordance with at least one aspect of the above computing device, the computing device may be configured to perform further operations including generating an event notification to update a member link associated with the external member, indicating a non-compliant status of the external member.

In accordance with at least one aspect of the above computing device, flagging the external member as the non-compliant member of the shared collaborative channel comprises causing the computing device to perform further operations including determining whether the external member is flagged as non-compliant, in response to a determination that the external member is not flagged as non-compliant, flagging the external member as the non-compliant member of the shared collaborative channel, in response to a determination that the external member is flagged as non-compliant, determining a period of time that the external member has been flagged as non-compliant, determining whether the period of time exceeds a predetermined time period, and in response to a determination that the period of time exceeds the predetermined time period, terminating a membership of the external member to the shared collaborative channel.

In accordance with at least one aspect of the above computing device, the computing device may be configured to perform further operations including in response to a determination that the external member is in compliance with both the first cross-tenant access policy of the home tenant and the second cross-tenant access policy of the resource tenant, determining if the external member is flagged as non-compliant, and in response to a determination that the external member is flagged as non-compliant, unflagging the external member as non-compliant.

In accordance with at least one aspect of the above computing device, the computing device may be configured to perform further operations including determining if the cross-tenant access policy check has been performed for all external members of the shared collaborative channel.

In accordance with at least one aspect of the above computing device, the computing device may be configured to perform further operations including receiving an update to at least one of the first cross-tenant access policy of the home tenant and the second cross-tenant access policy of the resource tenant, and performing the cross-tenant access policy check based on the update.

In accordance with at least one example of the present disclosure, a computer-readable medium storing instructions for enforcing cross-tenant access policies during collaboration between internal users associated with a resource tenant and external users associated with a home tenant is provided. The instructions when executed by one or more processors of a computing device, cause the computing device to perform operations including hosting, by the resource tenant, a shared collaborative channel, wherein the shared collaborative channel facilitates the collaboration between internal members associated with the resource tenant and external members associated with the home tenant, wherein the shared collaborative channel includes one or more resources associated with the collaboration, and wherein the one or more resources are hosted on the resource tenant; receiving a first cross-tenant access policy of the home tenant and a second cross-tenant access policy of the resource tenant, wherein the first cross-tenant access policy and the second cross-tenant access policy define access to the one or more resources by the external members of the shared collaborative channel; performing a cross-tenant access policy check for each external member of the shared collaborative channel to determine whether the external member is in compliance with the first cross-tenant access policy of the home tenant and the second cross-tenant access policy of the resource tenant; and in response to a determination that the external member is not in compliance with one of the first cross-tenant access policy of the home tenant or the second cross-tenant access policy of the resource tenant, flagging the external member as a non-compliant member of the shared collaborative channel; and generating an event notification to update a member link associated with the external member to indicate a non-compliant status of the external member.

In accordance with at least one aspect of the above computer-readable medium, the instructions when executed by the one or more processors may further cause the computing device to perform further operations including receiving at least one attribute for each external member of the shared collaborative channel, and performing the cross-tenant access policy check by comparing the attribute of each external member to the rules of the first cross-tenant access policy of the home tenant and the second cross-tenant access policy of the resource tenant.

In accordance with at least one aspect of the above computer-readable medium, wherein flagging the external member as the non-compliant member of the shared collaborative channel may cause the computing device to perform further operations including determining whether the external member is flagged as non-compliant, and in response to determining that the external member is not flagged as non-compliant, flagging the external member as the non-compliant member of the shared collaborative channel.

In accordance with at least one aspect of the above computer-readable medium, the instructions when executed by the one or more processors may further cause the computing device to perform further operations including in response to a determination that the external member is flagged as non-compliant, determining a period of time that the external member has been flagged as non-compliant, determining whether the period of time exceeds a predetermined time period, and in response to a determination that the period of time exceeds the predetermined time period, terminating a membership of the external member to the shared collaborative channel.

In accordance with at least one aspect of the above computer-readable medium, the instructions when executed by the one or more processors may further cause the computing device to perform further operations including in response to a determination that the external member is in compliance with both the first cross-tenant access policy of the home tenant and the second cross-tenant access policy of the resource tenant, determining if the external member is flagged as non-compliant, and in response to a determination that the external member is flagged as non-compliant, unflagging the external member as non-compliant.

In accordance with at least one aspect of the above computer-readable medium, the instructions when executed by the one or more processors may further cause the computing device to perform further operations including receiving an update to at least one of the first cross-tenant access policy of the home tenant and the second cross-tenant access policy of the resource tenant, and performing the cross-tenant access policy check based on the update.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

What is claimed is:

1. A method for enforcing cross-tenant access policies during collaboration between internal users associated with a resource tenant and external users associated with a home tenant, the method comprising:
hosting, by the resource tenant, a shared collaborative channel, wherein the shared collaborative channel facilitates the collaboration between internal members associated with the resource tenant and external members associated with the home tenant, wherein the shared collaborative channel includes one or more resources associated with the collaboration, and wherein the one or more resources are hosted on the resource tenant;
receiving a first cross-tenant access policy of the home tenant and a second cross-tenant access policy of the resource tenant, wherein the first cross-tenant access policy and the second cross-tenant access policy define access to the one or more resources by the external members of the shared collaborative channel;
performing a cross-tenant access policy check for each external member of the shared collaborative channel to determine whether the external member is in compliance with the first cross-tenant access policy of the home tenant and the second cross-tenant access policy of the resource tenant; and
in response to determining that the external member is not in compliance with at least one of the first cross-tenant access policy of the home tenant or the second cross-tenant access policy of the resource tenant, flagging the external member as a non-compliant member of the shared collaborative channel.

2. The method of claim 1, further comprising:
receiving at least one attribute for each external member of the shared collaborative channel; and
performing the cross-tenant access policy check by comparing the attribute of each external member to the rules of the first cross-tenant access policy of the home tenant and the second cross-tenant access policy of the resource tenant.

3. The method of claim 1, further comprising generating an event notification to update a member link associated with the external member, indicating a non-compliant status of the external member.

4. The method of claim 1, wherein flagging the external member as the non-compliant member of the shared collaborative channel comprises:
determining whether the external member is flagged as non-compliant; and
in response to determining that the external member is not flagged as non-compliant, flagging the external member as the non-compliant member of the shared collaborative channel.

5. The method of claim 4, further comprising:
in response to determining that the external member is flagged as non-compliant, determining a period of time that the external member has been flagged as non-compliant;
determining whether the period of time exceeds a predetermined time period; and
in response to determining that the period of time exceeds the predetermined time period, terminating a membership of the external member to the shared collaborative channel.

6. The method of claim 1, further comprising:
in response to determining that the external member is in compliance with both the first cross-tenant access policy of the home tenant and the second cross-tenant access policy of the resource tenant, determining if the external member is flagged as non-compliant; and
in response to determining that the external member is flagged as non-compliant, unflagging the external member as non-compliant.

7. The method of claim 1, further comprising determining if the cross-tenant access policy check has been performed for all external members of the shared collaborative channel.

8. The method of claim 1, further comprising:
receiving an update to at least one of the first cross-tenant access policy of the home tenant and the second cross-tenant access policy of the resource tenant; and
performing the cross-tenant access policy check based on the update.

9. A computing device for enforcing cross-tenant access policies during collaboration between internal users associated with a resource tenant and external users associated with a home tenant, the computing device comprising:
a processor; and
a memory having a plurality of instructions stored thereon that, when executed by the processor, causes the computing device to perform operations, comprising:
hosting, by the resource tenant, a shared collaborative channel, wherein the shared collaborative channel facilitates the collaboration between internal members associated with the resource tenant and external members associated with the home tenant, wherein the shared collaborative channel includes one or more resources associated with the collaboration, and wherein the one or more resources are hosted on the resource tenant;
receiving a first cross-tenant access policy of the home tenant and a second cross-tenant access policy of the resource tenant, wherein the first cross-tenant access policy and the second cross-tenant access policy define access to the one or more resources by the external members of the shared collaborative channel;
receiving at least one attribute for each external member of the shared collaborative channel;
performing a cross-tenant access policy check for each external member of the shared collaborative channel to determine whether the external member is in compliance with the first cross-tenant access policy of the home tenant and the second cross-tenant access policy of the resource tenant by comparing the attribute of each external member to the rules of the first cross-tenant access policy of the home tenant and the second cross-tenant access policy of the resource tenant; and
in response to a determination that the external member is not in compliance with at least one of the first cross-tenant access policy of the home tenant or the second cross-tenant access policy of the resource tenant, flagging the external member as a non-compliant member of the shared collaborative channel.

10. The computing device of claim 9, the plurality of instructions when executed by the processor causing the computing device to perform further operations, comprising:
generating an event notification to update a member link associated with the external member, indicating a non-compliant status of the external member.

11. The computing device of claim 9, wherein to flag the external member as the non-compliant member of the shared collaborative channel comprises causing the computing device to:
determining whether the external member is flagged as non-compliant;
in response to a determination that the external member is not flagged as non-compliant, flagging the external member as the non-compliant member of the shared collaborative channel;
in response to a determination that the external member is flagged as non-compliant, determining a period of time that the external member has been flagged as non-compliant;
determining whether the period of time exceeds a predetermined time period; and
in response to a determination that the period of time exceeds the predetermined time period, terminating a membership of the external member to the shared collaborative channel.

12. The computing device of claim 9, the plurality of instructions when executed by the processor causing the computing device to perform further operations, comprising:
in response to a determination that the external member is in compliance with both the first cross-tenant access policy of the home tenant and the second cross-tenant access policy of the resource tenant, determining if the external member is flagged as non-compliant; and
in response to a determination that the external member is flagged as non-compliant, unflagging the external member as non-compliant.

13. The computing device of claim 9, the plurality of instructions when executed by the processor causing the computing device to perform further operations, comprising:
determining if the cross-tenant access policy check has been performed for all external members of the shared collaborative channel.

14. The computing device of claim 9, the plurality of instructions when executed by the processor causing the computing device to perform further operations, comprising:
receiving an update to at least one of the first cross-tenant access policy of the home tenant and the second cross-tenant access policy of the resource tenant; and
performing the cross-tenant access policy check based on the update

15. A computer-readable medium storing instructions for enforcing cross-tenant access policies during collaboration between internal users associated with a resource tenant and external users associated with a home tenant, the instructions when executed by one or more processors of a computing device, cause the computing device to perform operations, comprising:
hosting, by the resource tenant, a shared collaborative channel, wherein the shared collaborative channel facilitates the collaboration between internal members associated with the resource tenant and external members associated with the home tenant, wherein the shared collaborative channel includes one or more resources associated with the collaboration, and wherein the one or more resources are hosted on the resource tenant;
receiving a first cross-tenant access policy of the home tenant and a second cross-tenant access policy of the resource tenant, wherein the first cross-tenant access policy and the second cross-tenant access policy define access to the one or more resources by the external members of the shared collaborative channel;
performing a cross-tenant access policy check for each external member of the shared collaborative channel to determine whether the external member is in compliance with the first cross-tenant access policy of the home tenant and the second cross-tenant access policy of the resource tenant;
in response to a determination that the external member is not in compliance with one of the first cross-tenant access policy of the home tenant or the second cross-tenant access policy of the resource tenant, flagging the external member as a non-compliant member of the shared collaborative channel; and
generating an event notification to update a member link associated with the external member to indicate a non-compliant status of the external member.

16. The computer-readable medium of claim 15, wherein the instructions when executed by the one or more processors cause the computing device to perform further operations, comprising:
receiving at least one attribute for each external member of the shared collaborative channel; and
performing the cross-tenant access policy check by comparing the attribute of each external member to the rules of the first cross-tenant access policy of the home tenant and the second cross-tenant access policy of the resource tenant.

17. The computer-readable medium of claim 15, wherein flagging the external member as the non-compliant member of the shared collaborative channel comprises:
determining whether the external member is flagged as non-compliant; and
in response to determining that the external member is not flagged as non-compliant, flagging the external member as the non-compliant member of the shared collaborative channel.

18. The computer-readable medium of claim 17, wherein the instructions when executed by the one or more processors cause the computing device to perform further operations, comprising:
in response to a determination that the external member is flagged as non-compliant, determining a period of time that the external member has been flagged as non-compliant;
determining whether the period of time exceeds a predetermined time period; and
in response to a determination that the period of time exceeds the predetermined time period, terminating a membership of the external member to the shared collaborative channel.

19. The computer-readable medium of claim 15, wherein the instructions when executed by the one or more processors cause the computing device to perform further operations, comprising:
in response to a determination that the external member is in compliance with both the first cross-tenant access policy of the home tenant and the second cross-tenant access policy of the resource tenant, determining if the external member is flagged as non-compliant; and
in response to a determination that the external member is flagged as non-compliant, unflagging the external member as non-compliant.

20. The computer-readable medium of claim 15, wherein the instructions when executed by the one or more processors cause the computing device to perform further operations, comprising:
receiving an update to at least one of the first cross-tenant access policy of the home tenant and the second cross-tenant access policy of the resource tenant; and
performing the cross-tenant access policy check based on the update.
